(19) United States
(12) Patent Application Publication
(10) Pub. No.: US 2013/0128264 A1
(43) Pub. Date: May 23, 2013

(54) SINGLE-MODE OPTICAL FIBER-BASED ANGLE-RESOLVED LOW COHERENCE INTERFEROMETRIC (LCI)(A/LCI) AND NON-INTERFEROMETRIC SYSTEMS AND METHODS

(71) Applicants: Adam Wax, Chapel Hill, NC (US); Yizheng Zhu, Blacksburg, VA (US)

(72) Inventors: Adam Wax, Chapel Hill, NC (US); Yizheng Zhu, Blacksburg, VA (US)

(73) Assignee: DUKE UNIVERSITY, Durham, NC (US)

(21) Appl. No.: 13/636,076

(22) PCT Filed: Mar. 19, 2010
(86) PCT No.: PCT/US10/27972

§ 371 Date: Feb. 4, 2013

(51) Int. Cl. G01N 21/47

(52) U.S. Cl. CPC G01N 21/4795
USPC 356/300

(57) ABSTRACT

Optical fiber-based angle-resolved low coherence interferometric systems and methods are disclosed for imaging of scattering samples and measurement of optical and structural properties. A single-mode collection optical fiber can be employed and scanned to collect an angular scattering distribution of scattered light from the sample. Use of a single-mode collection optical fiber can reduce cost, increase signal accuracy, and provide compatibility with optical coherence tomography systems, as examples. In certain embodiments, collected angular scatterings of light from the sample are cross-correlated with a reference signal to provide an angular scattering distribution of scattering of light from the sample. The angular scattering distribution can be spectrally dispersed to yield an angle-resolved, spectrally-resolved cross-correlation profile having depth-resolved information about the sample at the scattering angles. The angle-resolved, spectrally-resolved cross-correlation profile can be analyzed to provide size and/or depth information about the sample. The systems and methods can also be employed in non-interferometric modes.

### RELATED APPLICATIONS

This patent application is related to U.S. Pat. No. 7,102,758, filed on May 6, 2003 and entitled “Fourier Domain Low-Coherence Interferometry for Light Scattering Spectroscopy Apparatus and Method,” which is incorporated herein by reference in its entirety.

This patent application is also related to U.S. Pat. No. 7,595,889, filed on Oct. 11, 2006 and entitled “Systems and Methods for Endoscopic Angle-Resolved Low Coherence Interferometry,” which is incorporated herein by reference in its entirety.

This patent application is also related to U.S. patent application Ser. No. 12/210,620, filed on Sep. 15, 2008 and entitled “Apparatuses, Systems, and Methods for Low-Coherence Interferometry (LCI),” which is incorporated herein by reference in its entirety.

This patent application is also related to U.S. patent application Ser. No. 12/350,689, filed on Jan. 8, 2009 and entitled “Systems and Methods for Tissue Examination, Diagnostic, Monitoring, and/or Monitoring,” which is incorporated herein by reference in its entirety.

This patent application is also related to U.S. patent application Ser. No. 11/780,879, filed on Jul. 20, 2007 and entitled “Protective Probe Tip, Particularly for Use on a Fiber-Optic Probe Used in an Endoscopic Application,” which is incorporated herein by reference in its entirety.

This patent application is also related to U.S. Provisional Patent Application No. 61/297,588, filed on Jan. 22, 2010 and entitled “Dual Window Processing Schemes for Spectroscopic Optical Coherence Tomography (OCT) and Fourier Domain Low Coherence Interferometry,” which is incorporated herein by reference in its entirety.

### BACKGROUND

1. Field of the Disclosure

The technology of the disclosure relates to low coherence interferometric (LCI) systems and methods for the imaging of scattering samples and the measurement of their optical and structural properties.

2. Technical Background

Examining the structural features of cells is essential for many clinical and laboratory studies. The most common tool used in the examination for the study of cells has been the microscope. Although microscopic examination has led to great advances in understanding cells and their structure, it is inherently limited by the artifacts of preparation. The characteristics of the cells can only be seen at one moment in time with their structural features altered because of the addition of chemicals. Further, invasion is necessary to obtain the cell sample for examination.

Thus, light scattering spectrography (LSS) was developed to allow for in vivo examination applications, including cells. The LSS technique examines variations in the elastic scattering properties of cell organelles to infer their sizes and other dimensional information. In order to measure cellular features in tissues and other cellular structures, it is necessary to distinguish the singly scattered light from diffused light, which has been multiply scattered and no longer carries easily accessible information about the scattering objects. This distinction or differentiation can be accomplished in several ways, such as the application of a polarization grating, by restricting or limiting studies and analysis to weakly scattering samples, or by using modeling to remove the diffused component(s).

As an alternative approach for selectively detecting singly scattered light from sub-surface sites, low coherence interferometry (LCI) has also been explored as a method of LSS. LCI utilizes a light source with low temporal coherence, such as a broadband white light source for example. Interference is achieved when the path length delays of an interferometer are matched with the coherence time of the light source. The axial resolution of the system is determined by the coherent length of the light source and is typically in the micrometer range suitable for the examination of tissue samples. Experimental results have shown that using a broadband light source and its second harmonic allows the recovery of information about elastic scattering using LCI. LCI has used time depth scans by moving the sample with respect to a reference arm directing the light source onto the sample to receive scattering information from a particular point on the sample. Thus, scan times were on the order of five (5) to thirty (30) minutes in order to completely scan the sample.

Angle-resolved LCI (a/LCI) has been developed as a means to obtain sub-surface structural information regarding the size of a cell. In this regard, light is split into a reference beam and a sample beam, wherein the sample beam is projected onto the sample at different angles to examine the angular scattering distribution of scattered light. The a/LCI technique combines the ability of LCI to detect singly scattered light from sub-surface sites with the capability of light scattering methods to obtain structural information with sub-wavelength precision and accuracy to construct depth-resolved tomographic images. Structural information is determined by examining the angular scattering distribution of the back-scattered light using a single broadband light source mixed with a reference field with an angle of propagation.

The a/LCI technique has been successfully applied to measuring cellular morphology and to diagnosing intraepithelial neoplasia in an animal model of carcinogenesis. The a/LCI method of obtaining structural information about a sample has been successfully applied to measuring cellular morphology in tissues and in vitro as well as diagnosing intraepithelial neoplasia and assessing the efficacy of chemopreventive agents in an animal model of carcinogenesis. a/LCI has been used to prospectively grade tissue samples without tissue processing, demonstrating the potential of the technique as a biomedical diagnostic.

### SUMMARY OF THE DETAILED DESCRIPTION

Embodiments disclosed in the detailed description include optical fiber-based angle-resolved low coherence interferometric (LCI) (a/LCI) systems and methods that can be employed for the imaging of scattering samples and the measurement of their optical and structural properties. The a/LCI systems and methods disclosed herein can employ a single-mode collection optical fiber that is scanned at a multitude of scattering angles with respect to the sample of interest to collect an angular scattering distribution of scattered light from the sample. Use of a single-mode collection optical fiber to collect an angular scattering distribution of scattered light from the sample can provide several non-limiting advantages. In certain embodiments, only one (1) single-mode collection optical fiber is employed.

For example, a multi-mode optical fiber collection bundle can be employed that includes a plurality of optical fibers each configured to collect a particular angle of scattering of light from the sample. The collection of angles of scattering of light from the sample can provide an angular scattering distribution of scattered light from the sample to provide depth-resolved spectral information about the sample. However, providing a plurality of multi-mode optical fibers in an optical fiber collection bundle can be more costly. Further, modal dispersion issues can be present from the use of multi-mode optical fibers, thereby reducing the accuracy of the interference produced by the cross-correlation of a reference signal with a scattering of light signal from a sample. To minimize issues than can arise from modal dispersion, the length of each of the multi-mode optical fibers can be precisely controlled to be the same length such that the few modes are excited in the multi-mode optical fibers. However, this precise length control may be more costly. Use of a single-mode optical fiber collection bundle can also be employed, but providing a plurality of single-mode collection optical fibers is more costly than employing one single-mode collection optical fiber. Further, by providing a scanning of the single-mode collection optical fiber about the sample, the a/LCI systems and methods disclosed herein may be compatible with standard optical coherence tomography (OCT) systems, which may permit the a/LCI systems to directly incorporate equipment already developed for OCT systems. Further, using a single-mode collection optical fiber in an a/LCI system, a single channel spectrometer can be employed to receive the angle-resolved, cross-correlated sample signal rather than an imaging spectrometer, resulting in a simplified and compact system design and reduce cost, as examples.

In this regard, in certain embodiments disclosed herein, a light source is provided. A reference signal and a sample signal are split from a light emitted by the light source. The sample signal is directed towards a sample of interest at an angle. The single-mode collection optical fiber can be translated relative to the optical axis of the sample to collect various angular scatterings of light from the sample at a multitude of scattering angles. In this regard, the single-mode collection optical fiber can be scanned at the multitude of angles about the sample to collect various scattered sample light from the sample at the multitude of scattering angles. The collected scatterings of scattered sample light from the sample are mixed or cross-correlated with the reference signal to provide a cross-correlated signal with the interference term. The cross-correlated signal can then be spectrally dispersed by a spectrometer to yield a spectrally-resolved, cross-correlated signal having depth-resolved information about the sample at the given scan angle of the single-mode collection optical fiber. Thus, by scanning the single-mode collection optical fiber at a multitude of angles with respect to the sample, an angular scattering distribution of the spectrally-resolved, cross-correlated signals at each scattering angle can be determined and provided. Thus, the angular scattering distribution of the spectrally-resolved, cross-correlated signals can be processed by a control system to determine size characteristics about the sample.

Further, the angular scattering distribution of the spectrally-resolved, cross-correlated signals can be Fourier transformed to produce depth information and characteristics about the sample. In this instance, the a/LCI system and method can be characterized as a Fourier domain a/LCI (fa/LCI) system and method. Various mathematical techniques and methods are provided for determining size and/or depth information about the sample. Other embodiments of a/LCI systems employing a single-mode collection optical fiber are also disclosed. Non-interferometric systems employing a single-mode collection optical fiber are also disclosed.

These methods, processes, techniques, and systems disclosed herein offer an opportunity to significantly improve the standard of care for patients and decrease overall health care costs by diagnosing and treating tissue conditions, including pre-cancerous and cancerous conditions, in vivo. The methods, processes, and techniques disclosed herein effectively reduce the treatment time to the time of a first medical procedure on the patient, thus providing earlier treatment and potentially better and more timely results at a lower cost. This also provides more accurate diagnosis and determination of treatment effectiveness since the monitoring is performed on a localized level with the ability to diagnose, treatment, and monitor the affected tissue during the same or concomitant medical procedure or examination. The above-described methods, processes, techniques, and systems also enable more efficient diagnosis, treatment, and monitoring, or throughput of patients. This may be particularly important where health facilities and appointments are a limited resource.

The a/LCI systems and methods described herein can be clinically viable methods for assessing tissue health without the need for tissue extraction via biopsy or subsequent histopathological evaluation. The a/LCI systems and methods described herein can be applied for a number of purposes: for example, early detection and screening for dysplastic tissues, disease staging, monitoring of therapeutic action, and guiding the clinician to biopsy or surgery sites. The non-invasive, non-ionizing nature of the optical biopsy based on an a/LCI probe means that it can be applied frequently without adverse affect. The potential of a/LCI to provide rapid results will greatly enhance its widespread applicability for disease screening.

In addition to clinical activities, a real time optical biopsy such as a/LCI can be used in research activities, particularly those that track tissue health over time, such as in the study of chemo-preventatives. Real time a/LCI could be used to scan a tissue sample or cell culture at various points in time to assess changes in the status of the tissue or cells. For example a cell culture of cancer cells could be scanned and then treated with a chemo-preventative and then scanned at subsequent time points to see if the cancer cells were killed (such as by apoptosis) or not.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a schematic diagram of an exemplary Mach-Zender interferometer (MZI)-based system for angle-resolved low coherence interferometry (LCI) (a/LCI) employing a single-mode collection optical fiber;

FIG. 2 is an exemplary flowchart illustrating exemplary steps to recover an angle-resolved, spectrally-resolved profile having depth-resolved information about a sample using the MZI-based a/LCI system of FIG. 1;

FIG. 3A illustrates an exemplary depth-resolved angular scattering distribution of a double-layer phantom comprised of a coverslip and a microscope slide captured by the MZI-based a/LCI system of FIG. 1;

FIG. 3B illustrates an exemplary Mie analysis of the measured scattering pattern for the coverslip layer of the double-layer phantom captured by the MZI-based a/LCI system of FIG. 1;

FIG. 3C illustrates an exemplary Mie analysis of the measured scattering pattern for the microscope layer of the double-layer phantom captured by the MZI-based a/LCI system of FIG. 1;

FIG. 4 is a schematic diagram of an exemplary non-interferometric mode of the MZI-based a/LCI system of FIG. 1;

FIGS. 5A and 5B illustrate an exemplary p-polarized two-dimensional (2D) angular scattering distribution of an exemplary microsphere solution employing a non-interferometric mode of the MZI-based a/LCI system of FIG. 4; FIGS. 5C and 5D illustrate s-polarized 2D distributions of an exemplary microsphere solution the MZI-based a/LCI system of FIG. 4;

FIGS. 5E-5H illustrate corresponding Mie theory simulations to FIGS. 5A-5D, respectively;

FIG. 6A is a schematic diagram of an exemplary Michelson-Sagnac hybrid-mode interferometer (MSHI) for a/LCI measurement;

FIG. 6B is an exemplary diagram of signals from the MSHI of FIG. 6A relative to optical path lengths (OPLs);

FIG. 7A illustrates exemplary 2D angular scattering distributions of exemplary double-layer phantoms with parallel incidence and parallel scattering;

FIG. 7B illustrates exemplary 2D angular scattering distributions of exemplary double-layer phantoms with parallel incidence and perpendicular scattering;

FIG. 8 is a schematic diagram of an exemplary MSHI system that can be employed for optical coherence tomography (OCT) measurement; and

FIGS. 9A and 9B are schematic diagrams of exemplary LCI imaging schemes using Fourier-plane illumination.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include optical fiber-based angle-resolved low coherence interferometric (LCI) (a/LCI) systems and methods that can be employed for the imaging of scattering samples and the measurement of their optical and structural properties. The a/LCI systems and methods disclosed herein can employ a single-mode collection optical fiber that is scanned at a multitude of scattering angles with respect to the sample of interest to collect an angular scattering distribution of scattered light from the sample. In certain embodiments, only one (1) single-mode collection optical fiber is employed. Use of a single-mode collection optical fiber to collect an angular scattering distribution of scattered light from the sample can provide several non-limiting advantages.

For example, a multi-mode optical fiber collection bundle can be employed that includes a plurality of optical fibers each configured to collect a particular angle of scattering of light from the sample. The collection of angles of scattering of light from the sample can provide an angular scattering distribution of scattered light from the sample to provide depth-resolved spectral information about the sample. However, providing a plurality of multi-mode optical fibers in an optical fiber collection bundle can be more costly. Further, modal dispersion issues can be present from the use of multi-mode optical fibers, thereby reducing the accuracy of the interference produced by the cross-correlation of a reference signal with a scattering of light signal from a sample. To minimize issues than can arise from modal dispersion, the length of each of the multi-mode optical fibers can be précised controlled to be the same length such that the few modes are excited in the multi-mode optical fibers. However, this precise length control may be more costly. Use of a single-mode optical fiber collection bundle can also be employed, but providing a plurality of single-mode collection optical fibers is more costly than employing one single-mode collection optical fiber. Further, by providing a scanning of the single-mode collection optical fiber about the sample, the a/LCI systems and methods disclosed herein may be compatible with standard optical coherence tomography (OCT) systems, which may permit the a/LCI systems to directly incorporate equipment already developed for OCT systems.

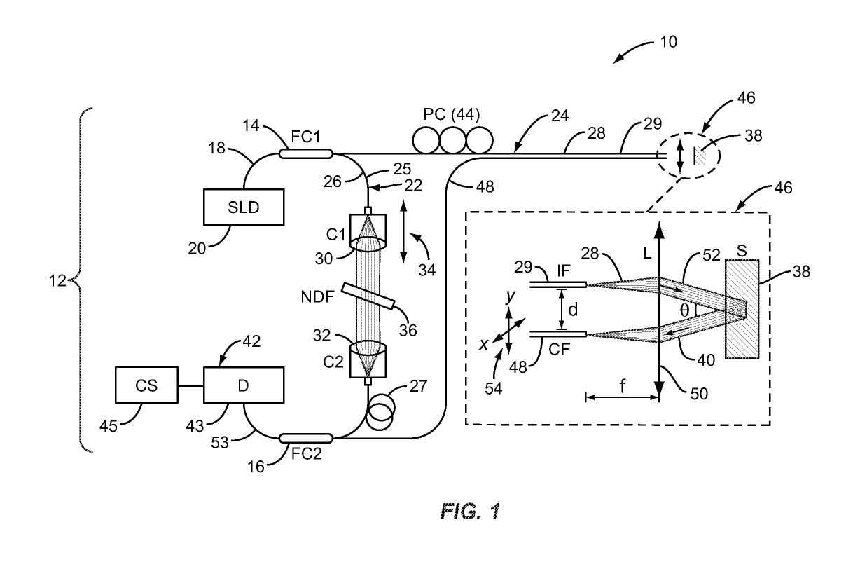

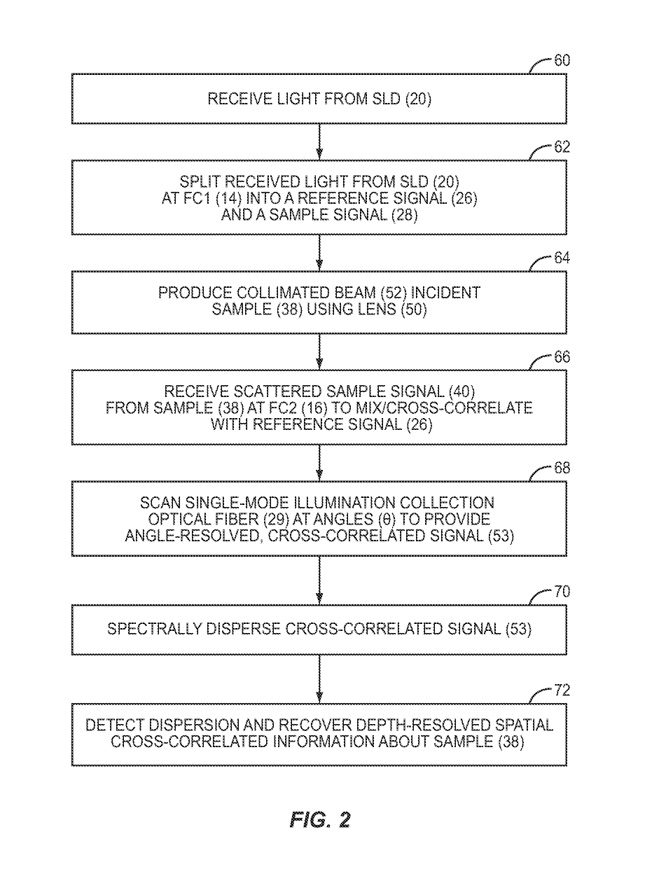

In this regard, FIG. 1 illustrates a first embodiment of an a/LCI system 10, which is based on a modified fiber-optic Mach-Zehnder interferometer (MZI) 12. The MZI 12 will be described below in conjunction with the flowchart in FIG. 2 providing exemplary steps of operation. The MZI 12 in this embodiment includes two (2) 90:10 single-mode optical fiber couplers, FC1 14 and FC2 16. FC1 14 splits a light beam or signal 18 emitted from a superluminescent diode (SLD) 20 (block 60 in FIG. 2) into a reference path or arm 22 and a sample path or arm 24. The reference arm 22 carries a reference signal 26 split from the light signal 18 by FC1 14 (block 62 in FIG. 2). In this embodiment, the reference arm 22 contains optical fiber 25, 27 from FC1 14 and FC2 16, respectively, that carry the reference signal 26 to FC2 16. The sample arm 24 carries a sample signal 28 split from the light signal 18 by FC1 14 (block 62 in FIG. 2). In this embodiment, the sample signal 28 is carried by an illumination optical fiber 29. The SLD 20 may emit a light signal 18 of any wavelength desired. For example, the SLD 20 may be an eight hundred thirty (830) nanometer (nm) SLD. Also, as an example, the SLD 20 may be an SLD produced by Superlum Diode, Ltd. with a bandwidth of seventeen nanometers (nm) (i.e., Δλ_{FWHM}=17 nm).

In this embodiment, the reference arm 22 connects the ten percent (10%) ports of both FC1 14 and FC2 16 using a pair of collimators C1 30 and C2 32. In this embodiment, C130 is mounted on a linear translation stage 34 to allow for adjustment of path length of the reference arm 22 for path length matching of the reference arm 22 to the sample arm 24. In this regard, as discussed below, a portion of the reference arm 22 contains free space optics that allow easy adjustment of the reference arm 22 for path length matching of the reference arm 22 to the sample arm 24. The intensity of the reference arm 22 can also be adjusted by insertion of a neutral density filter (NDF) 36. The sample arm 24 in this embodiment arranges the two (2) ninety percent (90%) ports of FC1 14 and FC2 16 in reflection mode. The port from FC1 14 illuminates a sample 38 of interest with the sample signal 28 split from the light signal 18. The port from FC2 16 collects the backscattering or scattering of light from the sample 38, or scattered sample light 40, as a result of illuminating the sample 38 with the sample signal 28, respectively.

The reference signal 26 and the scattered sample light 40 are then mixed at FC2 16 to generate interference for detection by a detector 42, which in this embodiment is an optical fiber-coupled miniature spectrometer 43. For example, the spectrometer 43 may be the HR4000 spectrometer manufactured by OceanOptics which contains a linear sensor with 3648 pixels. Because the angular scattering distribution of the scattered sample light 40 is polarization dependent in this embodiment, the incident polarization is controlled in order to effectively use Mie scattering models for data analysis. A polarization controller (PC) 44 is used to evenly distribute the sample signal 28 energy into p- and s-polarizations so that the Mie model based analysis can be implemented as the average of the two orientations. If linear polarization is desired, it can be achieved by the use of an in-line fiber polarizer and polarization-maintaining fibers and couplers.

With continuing reference to FIG. 1, a schematic of a single-mode optical fiber probe 46 that directs the sample signal 28 to the sample 38 and collects scattered sample light 40 from the sample 38 as a result of scattering of the sample signal 28 is illustrated. In this embodiment, the illumination optical fiber 29 coupled to FC1 14 is carrying the sample signal 28, and a single-mode collection optical fiber 48 coupled to FC2 16 is positioned to collect scattered sample light 40 from the sample 38. In this embodiment, one (1) single-mode collection optical fiber 48 is employed and scanned to receiving scattered sample light 40 from the sample 38. However, more than one single-mode collection optical fiber may be employed even if less than the number of scanning angles. For example, two (2) single-mode collection optical fibers may be employed and scanned wherein scattered sample light 40 at two angles are received by the single-mode collection optical fibers for each scan. Benefits can still be realized by using less number of single-mode collection optical fibers than scattering angles, although such is not required. The illumination optical fiber 29 and single-mode collection optical fiber 48 in this embodiment are positioned in the focal plane of a drum lens 50 (e.g., lens 50 is 3.0 mm in length; 2.4 mm in diameter; and has a 2.2 mm focal length). The lens 50 collimates the sample signal 28 and illuminates the sample 38 with a collimated beam 52 traveling at an angle θ relative to the optical axis of the sample 38 (block 64 in FIG. 2). The lens 50 also collects the scattered sample light 40 of light scattered at the specific angle θ back into the collection optical fiber 48 and provided to FC2 16 to be mixed or cross-correlated with the reference signal 26 from the reference arm 22 to provide a cross-correlated signal 53 containing the interference term from the mixed reference signal 26 and the scattered sample signal 40 (block 66 in FIG. 2).

In this embodiment, the collection optical fiber 48 is a single-mode optical fiber. Further, only one (1) single-mode optical fiber is provided in the collection optical fiber 48 in this embodiment. Thus, the collection optical fiber 48 is translated perpendicular to the optical axis of the sample 38 to collect different angles of scattered sample light 40 from the sample 38, as opposed to a fiber optic bundle that comprises a plurality of optical fibers that would each be arranged to collect different angles of scattered sample light 40 from the sample 38 in parallel. In this regard, the collection optical fiber 48 may be coupled to a motorized actuator 54 to acquire the angular scattering distribution of the scattered sample light 40 (block 68 in FIG. 2). The collection optical fiber 48 can be translated perpendicular to the optical axis in one (1) dimension (x) to acquire one-dimensional (1D) angular scattering distribution or two (2) dimensions (x and y) to acquire two-dimensional (2D) angular scattering distribution, as examples.

For convenience, θ is defined as the supplement of the conventional scattering angle (i.e., θ=0 radians (rad) corresponds to backscattering). The inter-fiber distance d between the illumination optical fiber 29 and the collection optical fiber 48 is scanned through a range (e.g., 0.25 mm, 1.35 mm) at a given speed (e.g., 0.1 mm/second (s)) collecting spectra at a multitude of angles with respect to the optical axis of the sample 38 (e.g., approximately one hundred sixteen (116) angles in twelve (12) seconds). This scanning profile results in a useful range (e.g., 0.27 mm, 1.23 mm, or 0.088 rad, 0.406 rad) correspondingly, and an angular resolution (e.g., 0.0032 rad). As will be discussed in more detail below, the collection of the angular scattering distribution of the scattered sample light 40 from the sample 38 can provide depth-resolved spectral information about the sample 38 that can be processed and analyzed by a control system 45 to determine size and/or depth characteristics about the sample 38.

Use of the single-mode collection optical fiber 48 to collect an angular scattering distribution of the scattered sample light 40 from the sample 38 can provide several non-limiting advantages. For example, a multi-mode optical fiber collection bundle could be employed that includes a plurality of optical fibers each configured to collect a particular angle of scattered sample light 40 from the sample 38 in FIG. 1. The collection of angles of scattered sample light 40 from the sample 38 can provide an angular scattering distribution to provide depth-resolved spectral information about the sample. However, providing a plurality of multi-mode optical fibers in an optical fiber collection bundle can be more costly. Further, modal dispersion issues can be present from the use of multi-mode optical fibers, thereby reducing the accuracy of the interference produced by the cross-correlation of a reference signal with a scattering of light signal from a sample. To minimize issues than can arise from modal dispersion, the length of each of the multi-mode optical fibers can be precisely controlled to be the same length such that the few modes are excited in the multi-mode optical fibers. However, this precise length control may be more costly, especially for longer length fiber bundles. Use of a single-mode optical fiber collection bundle could also be employed, but providing a plurality of single-mode collection optical fibers is more costly than employing the single-mode collection optical fiber 48. Further, by providing a scanning of the single-mode collection optical fiber 48 about the sample 38, the a/LCI systems and methods disclosed herein may be compatible with standard optical coherence tomography (OCT) systems, which may permit the a/LCI systems to directly incorporate equipment already developed for OCT systems. Further, using a single-mode collection optical fiber, a single channel spectrometer can be employed to receive the angle-resolved, cross-correlated sample signal rather than an imaging spectrometer, resulting in a simplified and compact system design and reduce cost, as examples.

The cross-correlated signal 53 enters the spectrometer 43 and is spectrally dispersed (block 70 in FIG. 2). By scanning the single-mode collection optical fiber 48 at a multitude of angles θ, the resulting cross-correlated signals 53 can be received by the spectrometer 43 and spectrally dispersed to provide an angular scattering distribution of the scattered sample light 40 from the sample 38. The signal intensity of the cross-correlated signal 53 detected by the spectrometer 43 (block 72 in FIG. 2), after resampling into wavenumber space, can be written as:

I(k,θ)=Iᵣ(k)+Iₛ(k,θ)+2η\sqrt{Iₛ(k,θ)Iᵣ(k)}cos[Δφ(k,θ)] (1)

where Iᵣ(k) is the reference arm intensity at wavenumber k and is independent of d and θ; Iₛ(k, θ) is the scattered sample light 40 from the sample 38 at angle θ; Δφ(k,θ) is the phase difference between the two fields; and η is a factor reflecting the system coupling efficiency and interference efficiency, which is assumed to be a constant. In the a/LCI system 10 of FIG. 1, Iₛ(k,θ) is negligible and hence signal processing involves the removal of only Iᵣ(k). The resultant interferometric term is then Fourier transformed to produce a depth scan for each scattering angle θ (block 72 in FIG. 2). Upon collection of the angular scattering distribution of the scattered sample light 40 from the sample 38 across the full range allowed by the a/LCI system 10, the result is compared to a Mie scattering database to determine the closest size match in this embodiment.

To obtain optimized depth resolution, the spectral dispersion of the cross-correlated signal 53 can be compensated prior to Mie theory analysis. This can be done based on the fact that the dispersion is the nonlinearity of Δφ(k,θ), or equivalently δφ(k,θ)=Δφ(k,θ)−kL, where L is the wavelength-independent best estimate of the optical path length difference between the reference and sample arms. To find L in this embodiment, the interference is first recorded using a mirror as sample and obtain the unwrapped phase Δφ′(k,θ), which differs from actual phase difference Δφ(k,θ) by 2mπ where m is a positive integer. Thus,

δφ(k,θ)=Δφ′(k,θ)+2mπ−kL (2)

Equation (2) is a least squares fitting problem that can generate an initial estimate of m and L. m is rounded to the nearest integer, [m], and used as a known parameter in Equation (2) for another linear regression to find the best estimate of L. The dispersion δφ(k,θ) then follows accordingly. Since the scanning single-mode collection optical fiber 48 alters the sample arm 24 path only minimally, it is assumed δφ(k,θ) is independent of θ, and hence apply the same dispersion compensation to all angles θ.

In a mirror experiment, it was found to be sufficient for the a/LCI system 10 in FIG. 1 to fit δφ(k) with a 3rd-order polynomial. After dispersion compensation, the full-width-at-half-maximum of the minor peak is improved from an uncompensated 23.2 micrometers (μm) to 18.5 μm, which is consistent with the theoretical depth resolution of 18.1 μm obtained from the source autocorrelation function. In this experiment, the dispersion only mildly degrades the theoretical value by approximately twenty eight percent (28%). By improving the matching of the reference arm 22 with the sample arm 24, (e.g., reducing the free space between C1 30 and C2 32), the degradation may be able to be further minimized and eliminate the need for dispersion compensation.

Depth and angular detection range are also important parameters for an a/LCI probe. An efficient method to evaluate these parameters can be provided by the use of a “scattering standard” that generates uniform angular scattering intensity across the probe's angular range (e.g., such as the 0.26 μm microspheres) (e.g., manufactured by Thermo Fisher Scientific, Inc. with a 10% standard deviation). The microspheres can be suspended in a density-matching mixture of eighty percent (80%) water and twenty percent (20%) glycerol and used to fill a one (1) mm-thick chamber sandwiched by a No. 1 coverslip and a microscope slide. To avoid detecting reflection from the interfaces by the single-mode collection optical fiber 48, the sample 38 is slightly tilted out of plane.

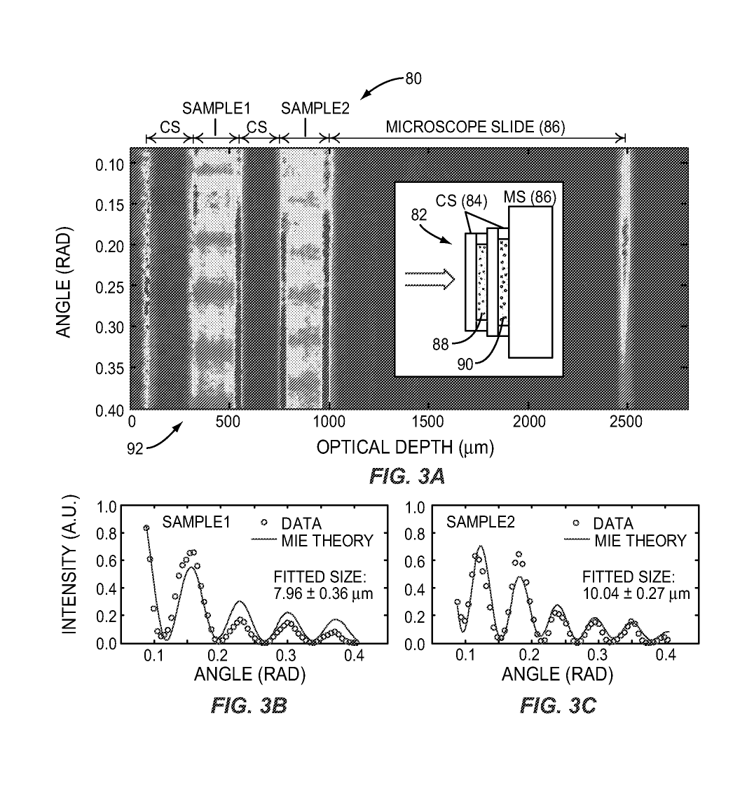

The depth-resolved sizing capability of the scanning single-mode optical fiber probe 46 can be demonstrated using a double-layer phantom. In this regard, FIG. 3A illustrates an exemplary depth-resolved angular scattering distribution 80 of a double-layer phantom 82 comprised of a coverslip 84 and microscope slide 86 captured by the MZI-based a/LCI system 10 of FIG. 1. The double-layer phantom 82 in this embodiment consists of two chambers 88, 90 filled with solutions of National Institute of Standards and Technology (NIST) traceable microsphere size standards (e.g., Thermo Fisher Scientific, Inc.) that have mean diameters of 7.979 μm±0.055 μm and 10.00 μm±0.05 μm, and standard deviations of 1.1% and 0.9%, respectively, as an example. Each chamber 88, 90 has the same thickness as a No. 1 coverglass (e.g., ˜150 μm) as an example.

FIG. 3A also shows a depth-resolved one-dimensional (y direction) angular scattering distribution 92 of the double-layer phantom 82, where a multilayer structure is identified. Inside the two chambers 88, 90, strong scattering can be observed with the periodicity of the angular oscillations indicating different sizes. To determine the size of the scatterers, the scattered light from the sample is analyzed from the first 19 μm (matching the depth resolution) of the scattering signal from both chambers 88, 90 using Mie theory, as illustrated in FIGS. 3B and 3C. The results in this example, 7.96±0.36 μm and 10.04±0.27 μm, are in agreement with sample specifications and demonstrate the a/LCI system's 10 depth-resolved sizing capability with sub-wavelength accuracy.

In summary, the Fourier-domain a/LCI technique for determining size and depth characteristics of a sample can be based on a scanning of a single-mode optical fiber probe and a modified Mach-Zehnder interferometer, as provided by the example of the a/LCI system 10 in FIG. 1. This configuration offers several non-limiting advantages. For example, the a/LCI system 10 can be compatible with current OCT schemes which link a/LCI with many existing hardware and software platforms. Further, probe length restrictions are eliminated which could potentially lower the cost of fabrication, especially for long probes. Also, by use of the single-mode optical fiber implementation, a single channel spectrometer can be employed rather than an imaging spectrometer, resulting in a simplified and compact system design.

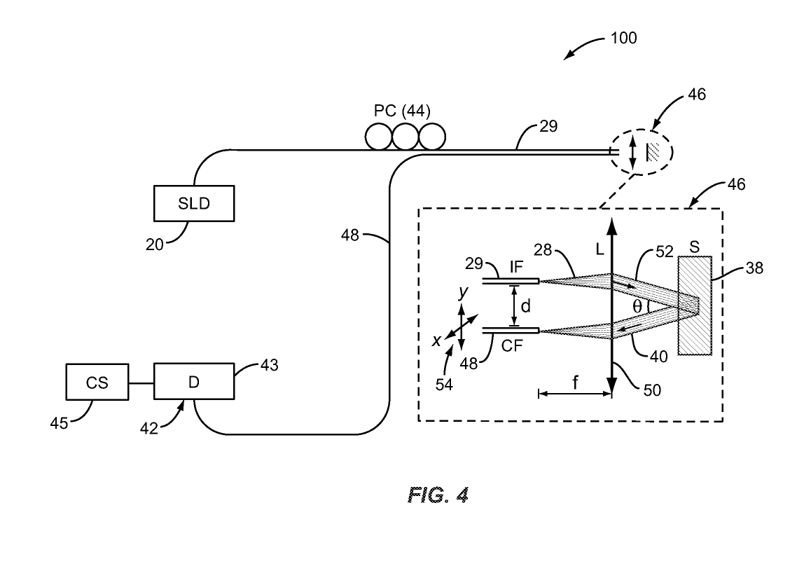

The MZI-based a/LCI system 10 in FIG. 1 can also be modified to be operated in a non-interferometric mode using the single-mode collection optical fiber 48. In this regard, FIG. 4 is provided that is a modified MZI-based a/LCI system 100 from the MZI-based a/LCI system 10 of FIG. 1. Where common elements are provided between the two systems 10, 100, common element numbers are included in FIG. 4 and thus will not be redescribed. In this embodiment of the a/LCI system 100 in FIG. 4, a non-interferometric operation can be achieved by either blocking the light path between C1 30 and C2 32 in the reference arm 22 of the a/LCI system 10 of FIG. 1, or by removing C130, C2 32, NDF 36, FC1 14 and FC2 16 in the a/LCI system 10 of FIG. 1 all together, as illustrated in the modified a/LCI system 100 in FIG. 4.

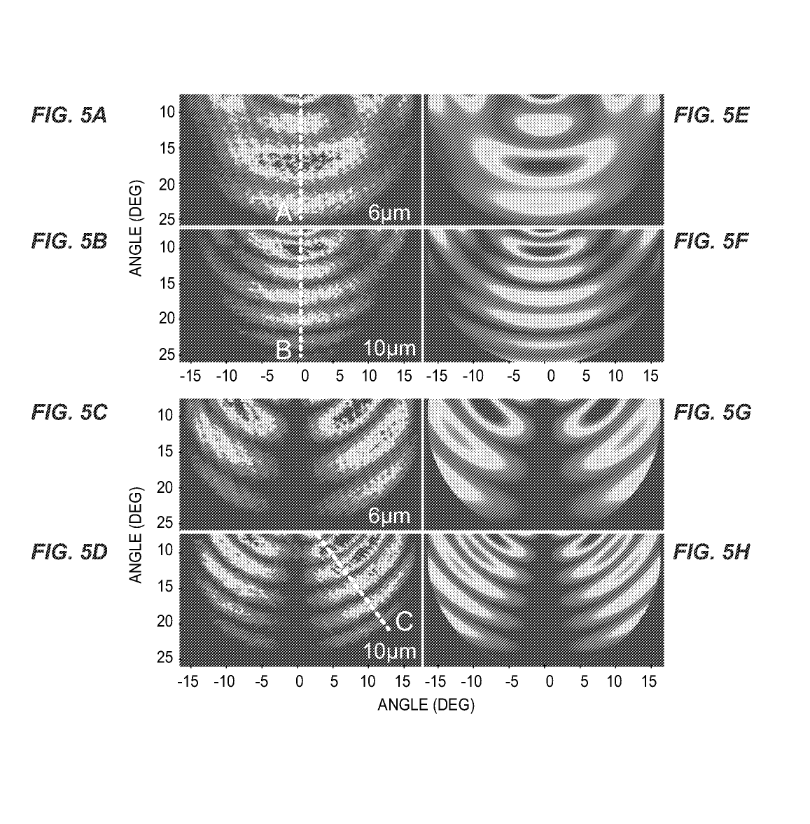

With reference to FIG. 4, the a/LCI system 100 provided therein collects the total power of the scattered sample light 40 at the same angle θ from all depths of the sample 38. FIGS. 5A-5H shows a sample of the two-dimensional angular scattering distribution 102 obtained with this non-interferometric mode of operation of the a/LCI system 100 of FIG. 4 by scanning the single-mode collection optical fiber 48 in two dimensions in this example, although scanning in one dimension is also possible. In this example, the test phantom used as the sample 38 was a ten (10) μm polymer microsphere suspended in water.

FIGS. 5A-5H show that the measured distribution for each layer and each polarization are in good agreement with the predictions of Mie theory. The speckle patterns seen in the experimental data are likely due to coherent scattering from adjacent microspheres in the phantom. Such information can be potentially useful for estimation of particle density and spacing. In this regard, FIGS. 5A and 5B illustrate p-polarized 2D distributions for layers containing 6 μm and 10 μm scatterers, respectively. FIGS. 5C and 5D illustrate s-polarized 2D distributions for layers containing 6 μm and 10 μm scatterers, respectively. FIGS. 5E-5H illustrate corresponding Mie theory simulations to FIGS. 5A-5D, respectively. Lines A, B and C in FIGS. 5A, 5B, and 5D, respectively, are lines along which data fitting is executed to assess the scatterer structure.

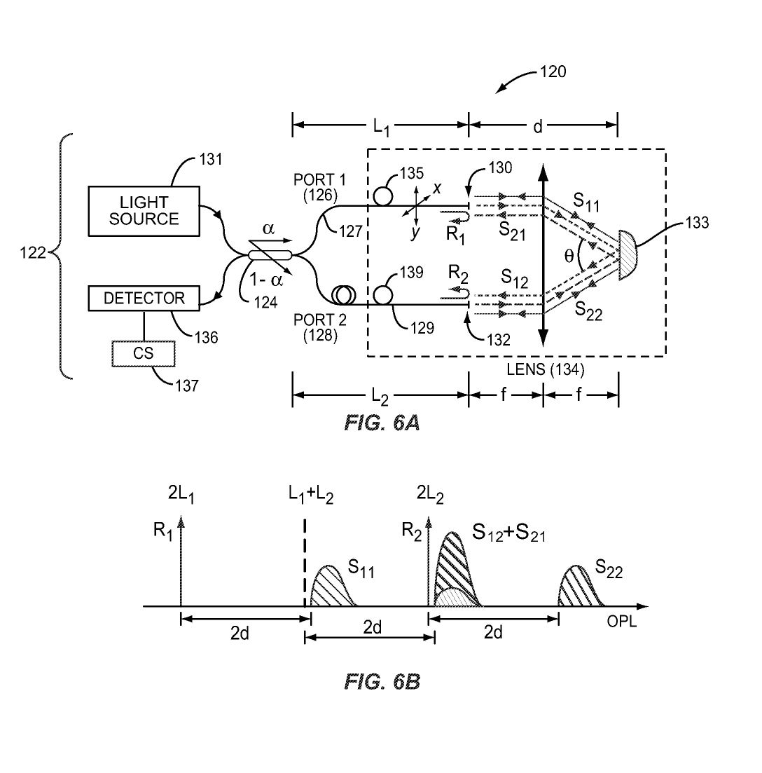

FIG. 6A is a schematic diagram of another exemplary a/LCI system 120 that can employ a single-mode collection optical fiber for an a/LCI measurement. In this regard, FIG. 6A provides a Michelson-Sagnac hybrid-mode interferometer (MSHI) 122 that can employ a single-mode collection optical fiber for a/LCI measurement. In one embodiment, the collection illumination optical fiber of the interferometer is scanned in two dimensions to detect angular scattering intensity from the sample, which can then be analyzed to determine the structure of the scatterers. One feature of this system is the full control of polarization of both the illumination and collection fields, allowing for polarization-sensitive detection which is used for inverse light scattering analysis based on two-dimensional angular measurements. System performance is demonstrated using a double-layer microsphere phantom. Experimental data from samples with different sizes and acquired with different polarizations show excellent agreement with Mie theory, producing structural measurements with sub-wavelength accuracy.

In this embodiment, the MSHI 122 is based on a single-mode fiber optic coupler (polarization-maintaining fibers and couplers if necessary). As illustrated in FIG. 6A, a single-mode fiber optic coupler 124 is provided that includes two arms, or a first port 126 and a second port 128, coupled to single-mode optical fibers 127, 129 having with optical path lengths L₁ and L₂, respectively. The single-mode optical fiber 127 is an illumination fiber and the single-mode optical fiber 129 is a collection fiber. The single-mode optical fiber 127 carries light from a light source 131 to a sample 133. For example, the light source 133 may be a Ti:Sapphire laser (e.g., manufactured by Coherent, Inc.: 825 nm, Δλ=17 nm) coupled into the single-mode fiber optic coupler 124 (e.g., coupling ratio α=0.01%). The single-mode optical fiber 129 collects scattered light from the sample 131 as a result of the sample 131 being illuminated. As will be described in more detail below, the optical path lengths L₁ and L₂, respectively, are provided of a special length differential that enables a hybrid mode operation by combining the Michelson and Sagnac signals. The cleaved or polished ends 130, 132 of both single-mode optical fibers 127, 129 are placed in the focal plane of a lens 134. In the presence of a scattering object, this configuration will generate six (6) returning signals at a detector 136, which may be a spectrometer, which may then been analyzed by a control system 137 to determine size and/or depth characteristics about the sample 133.

With continuing reference to FIG. 6A, Michelson signals R₁ and R₂ are reflections from the end of the single-mode optical fibers 127, 129. Backscattering signal S₁₁ and S₂₂ for each respective port 126, 128 can also be considered Michelson signals. Sagnac signals S₁₂ and S₂₁ are the cross-scattering signals between the two ports 126, 128, and are the signal of interest for a/LCI measurement. For clarity, hereinafter, capital letters are used to refer to a signal, and lowercase letters are used to refer to the corresponding reflection or scattering coefficient, for instance, s₁₂ as the scattering coefficient of signal S₁₂.

The signals' relative optical path lengths (OPLs) are illustrated in FIG. 6B. Note that the OPLs of R₁ and R₂ will determine that of the scattering signals. This is because the OPL of S₁₁ is 2 d longer than that of R₁, as is the case for S₂₂ and R₂. In addition, S₁₂ and S₂₁ have the same OPL that is 2 d longer than L₁+L₂, or the midpoint of R₁ and R₂ in this embodiment. This implies that signals can be path length matched by tuning the relative length of R₁ and R₂, or equivalently L₂-L₁ assuming L₂>L₁. For example, Sagnac signals S₁₂ and S₂₁ can be placed slightly to the long OPL side of Michelson signal R₂, as shown in FIG. 6B. By using R₂ as a reference, depth-resolved information about S₁₂ and S₂₁ can be obtained, thus achieving hybrid-mode operation with its matching condition written as

L₁−L₂=2d (3)

where d is determined by the focal length and thickness of the lens, usually a few millimeters at least. As a result, all other signals, except for R₁, S₁₂ and S₂₁, are far apart in OPL and in practice will not generate interference to be detected by Fourier-domain LCI.

As an example, the single-mode optical fibers 127, 129 can be cleaved and their facets are placed in the focal plane of a lens 134, which may be a graded index (GRIN) lens (e.g., Newport Corp.: 0.23 pitch, 1.8 mm diameter; 4.4 mm length) for illumination and collection. The lens 134 can be angled at eight degrees (8°), for example, on the sample 133 side to avoid or reduce the collection of specular reflection from the sample 133. The majority of source power is coupled into single-mode optical fiber 129, which serves as the illumination optical fiber. Its output is collimated via the lens 134, illuminating the area of interest on the sample 133. The single-mode optical fiber 127 is the low power arm and serves as the collection fiber that receives the light scattered at angle θ. To maximize the detectable angular range, the single-mode optical fiber 129 can be positioned toward the edge of the lens 134, whereas the single-mode optical fiber 127 can raster-scans in a 2D pattern using a pair of motorized actuators. The polarization of the illumination and collection fields can be tuned independently using polarization controllers 135, 139 to be linearly polarized along any direction with extinction ratio greater than 20 dB, making it possible to measure scattering under any combination of illumination and collection polarization. Return signals of the mixed sample and reference fields are detected by a miniature spectrometer.

The symmetry of this a/LCI system 120 points to the fact that R₂ can also serve as the reference signal, provided that L₂>L₁ and equation (3) holds. The difference between the two approaches is that using the low-power arm signal R₁ as the reference provides superior polarization performance to the use of the high-power arm signal R₂ as the reference. These two signals propagate together and fiber disturbance has no effect. The polarization component of S₂₁ that is detected by the interferometer is determined by the direction of the linearly polarized R₁ as it exits the fiber at the single-mode optical fiber 127, a parameter that can be measured and adjusted using a polarizer and a power meter. A similar procedure can be used for adjusting the illumination polarization as well. In summary, the a/LCI system 120 allows both the illumination and the collection to be either p- (y direction) or s- (x direction) polarized, offering full polarization control and hence enabling 2D capability.

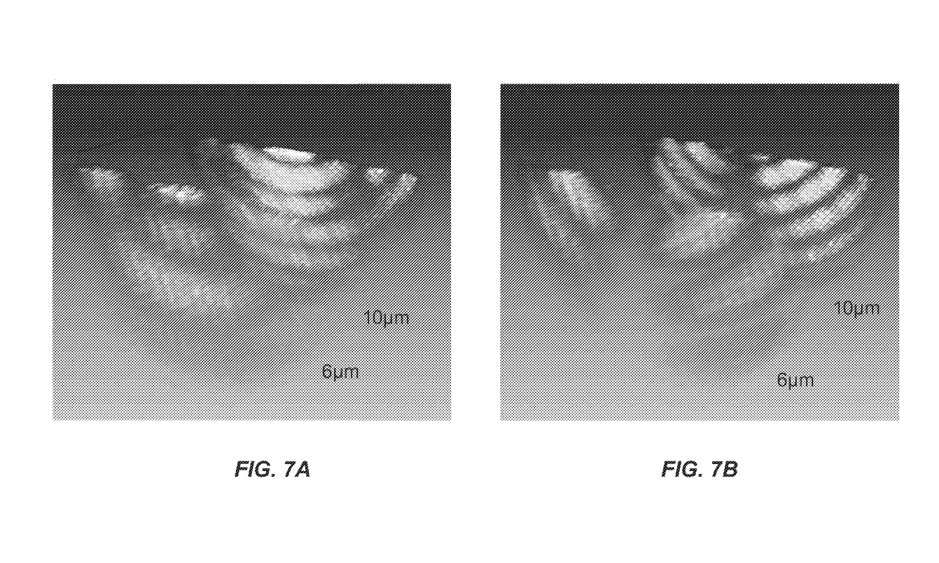

FIGS. 7A and 7B show the two-dimensional depth-resolved angular scattering distribution of a double-layer phantom consisting of microspheres (e.g., 6 μm and 10 μm) embedded in a solid polymer (PDMS) matrix, as an example of an angular scattering distribution produced by the MHSI 122 of FIG. 6A. The 2-layer structure is clearly visible that shows different scattering patterns for the two sizes. The incident light is parallel-polarized and FIGS. 7A and 7B show patterns for parallel and perpendicular-scattering, respectively. The double-layer phantom consisted of two chambers, each filled with heat-cured silicone with polystyrene (n=1.59) microspheres embedded within. NIST traceable microsphere size standards (Thermo Fisher Scientific, Inc.) with mean diameters of 5.990±0.045 μm and 10.00±0.05 μm, and standard deviations of 1.2% and 0.9%, respectively, are chosen for each chamber.

For example, single-mode optical fiber 127 raster scans an area of 1.0×1.8 mm² (y×x), which covers the detectable area of the lens 134, with a continuous scan (e.g., 0.35 mm/sec) in x and a step scan (e.g., 10 μm/step) in y direction. To compensate for any scan nonlinearity, the data are linearly resampled in x direction prior to analysis. A complete scan can take twelve (12) minutes and generates a 2D angular scattering distribution containing 90×170 data points, with an angular resolution of 0.212°/step in both directions, as an example. At each point of the 2D distribution, the interference spectrum can be processed and Fourier-transformed into depth-resolved scattering intensity with a depth resolution of 17.7 μm, as an example. To demonstrate polarization-sensitive measurements, p-polarized illumination can be used to collect both the p- and s-components of the scattered field.

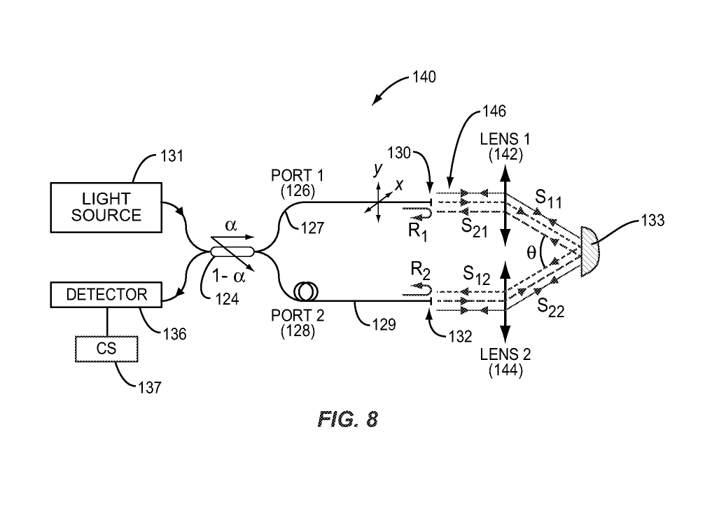

The MSHI 122 can also be applied for imaging scattering samples at a certain angle, as shown in an alternative MSHI a/LCI system 140 in FIG. 8. In this configuration, each of the two ports 126, 128 has a lens 142, 144 disposed in front of the ends 130, 132 of the single-mode optical fibers 127, 129, respectively. The single-mode optical fibers 127, 129 and the sample 133 are located at the image and object planes of the lenses 142, 144, respectively. Thus, the sample 133 can be imaged using light scattered at a certain angle to illumination light 146 from the light source 131.

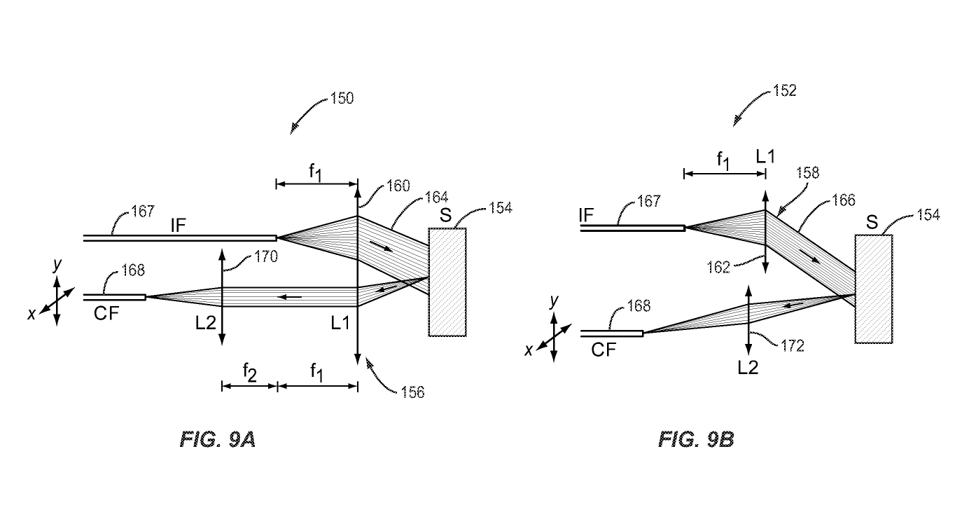

As previously discussed, the a/LCI systems described herein using a single-mode collection optical fiber may allow compatibility with OCT systems. Particularly, the a/LCI systems may be compatible with OCT systems if the fiber probes are replaced with alternative fiber probes. In this regard, FIGS. 9A and 9B provide examples of alternative probe assemblies 150, 152 that can replace the fiber probes shown inside the dashed boxes of the a/LCI systems 10 in FIG. 1, the a/LCI system 100 in FIG. 4, and the a/LCI system 120 in FIG. 6A, as examples. Unlike the conventional OCT, where a sample is illuminated from the image plane of the imaging lens, the two alternative fiber probes 150, 152 in FIGS. 9A and 9B illuminate a sample 154 from focal planes 156, 158, or the Fourier-plane of lens L₁ 160, 162, respectively. The lenses 160, 162 in the fiber probes 150, 152 produce collimated beams 164, 166 incident onto the sample 154 from light received from an illumination optical fiber 167 carrying light from a light source (not shown), which scatters light to be collected by a scanning single-mode collection optical fiber 168.

In the fiber probe 150 of FIG. 9A, lens L₁ 160 and lens L₂ 170 form a 4-f system that images points in the sample 154 into the single-mode collection optical fiber 168. In the fiber probe 152 of FIG. 9B, lens L₂ 172 alone provides the imaging function. Note that lens L₂ 170, 172 can be a single lens or a series of lenses with the same function. Similar to the a/LCI system 140 in FIG. 8, these fibers probes 150, 152 in FIGS. 9A and 9B can also provide images of the sample 154 using light scattered at a certain angle, which may enhance imaging contrast and reveal features otherwise difficult to identify.

The a/LCI systems and methods described herein can be clinically viable methods for assessing tissue health without the need for tissue extraction via biopsy or subsequent histopathological evaluation. For example, the ends of the illumination optical fiber and the single-mode collection optical fiber can be disposed in a fiber probe where the fiber probe is employed in an endoscopic probe of an endoscope used to examine tissue. The a/LCI systems and methods described herein can be applied for a number of purposes: for example, early detection and screening for dysplastic tissues, disease staging, monitoring of therapeutic action, and guiding the clinician to biopsy or surgery sites. The non-invasive, non-ionizing nature of the optical biopsy based on an a/LCI probe means that it can be applied frequently without adverse affect. The potential of a/LCI to provide rapid results will greatly enhance its widespread applicability for disease screening.

Nuclear morphology measurement is also possible using the a/LCI systems and methods described herein. Nuclear morphology is a necessary junction between a cell's topographical environment and its gene expression. One application of the a/LCI systems and methods is to connect topographical cues to stem cell function by investigating nuclear morphology. In one embodiment, the a/LCI systems and methods use a swept-source light source approach described herein and create and implement light scattering models. The second is to provide nuclear morphology as a function of nanotopography. Finally, by connecting nuclear morphology with gene expression, the structure-function relationship of stem cells, e.g., human mesenchymal stem cells (hMSC), under the influence of nanotopographic cues can be established.

The a/LCI methods, processes, techniques, and systems described herein can also be used for cell biology applications and medical treatment based on such applications. Accurate measurements of nuclear deformation, i.e., structural changes of the nucleus in response to environmental stimuli, are important for signal transduction studies. Traditionally, these measurements require labeling and imaging, and then nuclear measurement using image analysis. This approach is time-consuming, invasive, and unavoidably perturbs cellular systems. The a/LCI techniques described herein offer an alternative for probing physical characteristics of living systems. The a/LCI techniques disclosed herein can be used to quantify nuclear morphology for early cancer detection, diagnosis and treatment, as well as for noninvasively measuring small changes in nuclear morphology in response to environmental stimuli. With the a/LCI methods, processes, techniques, and systems provided herein, high-throughput measurements and probing aspherical nuclei can be accomplished. This is demonstrated for both cell and tissue engineering research. Structural changes in cell nuclei or mitochondria due to subtle environmental stimuli, including substrate topography and osmotic pressure, are profiled rapidly without disrupting the cells or introducing artifacts associated with traditional measurements. Accuracy of better than 3% can be obtained over a range of nuclear geometries, with the greatest deviations occurring for the more complex geometries.

In one embodiment disclosed herein, the a/LCI systems and methods described herein are used to assess nuclear deformation due to osmotic pressure. Cells are seeded at high density in chambered coverglasses and equilibrated with 500, 400 and 330 mOsm saline solution, in that order. Nuclear diameters are measured in micrometers to obtain the mean value +/− the standard error within a 95% confidence interval. Changes in nuclear size are detected as a function of osmotic pressure, indicating that the a/LCI systems and methods disclosed herein can be used to detect cellular changes in response to factors which affect cell environment. One skilled in the art would recognize that many biochemical and physiological factors can affect cell environment, including disease, exposure to therapeutic agents, and environmental stresses.

To assess nuclear changes in response to nanotopography, cells are grown on nanopatterned substrates which create an elongation of the cells along the axis of the finely ruled pattern. The a/LCI systems and processes disclosed herein are applied to measure the major and minor axes of the oriented spheroidal scatterers in micrometers through repeated measurements with varying orientation and polarization. A full characterization of the cell nuclei is achieved, and both the major axis and minor axis of the nuclei is determined, yielding an aspect ratio (ratio of minor to major axes).

The a/LCI systems and methods disclosed herein can also be used for monitoring therapy. In this regard, the a/LCI systems and methods are used to assess nuclear morphology and subcellular structure within cells (e.g., mitochondria) at several time points following treatment with chemotherapeutic agents. The light scattering signal reveals a change in the organization of subcellular structures that is interpreted using a fractal dimension formalism. The fractal dimension of sub-cellular structures in cells treated with paclitaxel and doxorubicin is observed to increase significantly compared to that of control cells. The fractal dimension will vary with time upon exposure to therapeutic agents, e.g., paclitaxel, doxorubicin and the like, demonstrating that structural changes associated with apoptosis are occurring. Using T-matrix theory-based light scattering analysis and an inverse light scattering algorithm, the size and shape of cell nuclei and mitochondria are determined. Using the a/LCI systems and methods disclosed herein, changes in sub-cellular structure (e.g., mitochondria) and nuclear substructure, including changes caused by apoptosis, can be detected. Accordingly, the a/LCI systems and processes described herein have utility in detecting early apoptotic events for both clinical and basic science applications.

Many modifications and other embodiments of the embodiments set forth herein will come to mind to one skilled in the art to which the embodiments pertain having the benefit of the teachings presented in the foregoing descriptions and the associated drawings.

This disclosure is not limited to any particular a/LCI arrangement. In one embodiment, the apparatus is based on a modified Mach-Zehnder interferometer, but other a/LCI interferometric arrangements are possible. Non-interferometric a/LCI arrangements are also possible.

As an alternative to processing the a/LCI data and comparing to Mie theory, there are several other approaches which could yield diagnostic information. These include analyzing the angular data using a Fourier transform to identify periodic oscillations characteristic of cell nuclei. The periodic oscillations can be correlated with nuclear size and thus will possess diagnostic value. Another approach to analyzing a/LCI data is to compare the data to a database of angular scattering distributions generated with finite element method (FEM) or T-Matrix calculations, as examples. Such calculations may offer superior analysis as there are not subject to the same limitations as Mie theory. For example, FEM or T-Matrix calculations can model non-spherical scatterers and scatterers with inclusions while Mie theory can only model homogenous spheres.

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

1. An apparatus for obtaining depth-resolved spectra of a sample for determining size and/or depth characteristics of scatterers within the sample, comprising:
a sample path comprised of an illumination optical fiber configured to carry a sample signal split from a light source, wherein the sample is illuminated with the sample signal at an angle producing scattered sample signals at a plurality of angles off of the sample;
a reference path configured to carry a reference signal split from the light source;
a single-mode collection optical fiber configured to be scanned about the sample to receive the scattered sample signals at the plurality of angles;
a fiber optic coupler configured to cross-correlate the reference signal and each of the plurality of the scattered sample signals at the plurality of angles to produce a plurality of cross-correlated signals each having depth-resolved information about the sample;
a detector that spectrally disperses the plurality of cross-correlated signals to yield a spectrally-resolved, angular scattering distribution of the scattered sample signals; and
a control system configured to analyze the spectrally-resolved, angular scattering distribution of the scattered sample signals to determine characteristic information of the scatterers within the sample.

2. (canceled)

3. The apparatus of claim 1, wherein the control system is configured to determine the depth characteristics of the scatterers within the sample when analyzing the spectrally-resolved, angular scattering distribution by Fourier transforming the spectrally-resolved, angular scattering distribution of the scattered sample signals.

4. (canceled)

5. The apparatus of claim 1, wherein the control system is configured to determine the size characteristics of the scatterers within the sample when analyzing the spectrally-resolved, angular scattering distribution by comparing the angular scattering distribution of the scattered sample signals to a predicted analytically or numerically calculated angular scattering distribution of the sample.

6. (canceled)

7. The apparatus of claim 1, further comprising an actuator configured to translate the single-mode collection optical fiber in at least two (2) dimensions about the sample to receive the scattered sample signals at the plurality of angles in the at least two (2) dimensions.

8. The apparatus of claim 1, wherein the single-mode collection optical fiber is positioned at an oblique angle to the sample so that specular reflections from the sample are not received by the single-mode collection optical fiber.

9-10. (canceled)

11. The apparatus of claim 1, wherein the illumination optical fiber and the single mode collection optical fiber are positioned in a focal plane of a lens disposed between the illumination optical fiber and the single-mode collection optical fiber and the sample.

12. The apparatus of claim 1, further comprising a polarizer disposed in the sample path.

13-15. (canceled)

16. The apparatus of claim 1, wherein ends of the illumination optical fiber and the single-mode collection optical fiber are disposed in a fiber probe.

17. The apparatus of claim 16, wherein the fiber probe is employed in an endoscopic probe of an endoscope used to examine tissue.

18. A method of obtaining depth-resolved spectra of a sample for determining size and/or depth characteristics of scatterers within the sample, comprising:
illuminating the sample at an angle with a sample signal split from a light source and carried by an illumination optical fiber in a sample path to produce scattered sample signals at a plurality of angles off of the sample;
splitting the light source into a reference signal carried in a reference path; scanning a single-mode collection optical fiber at a plurality of angles to the sample to receive the scattered sample signals at the plurality of angles;
cross-correlating the reference signal and each of the scattered sample signals at the plurality of angles to produce a plurality of cross-correlated signals each having depth-resolved information about the sample;
detecting the plurality of cross-correlated signals;
spectrally dispersing the plurality of cross-correlated signals to yield a spectrally-resolved, angular scattering distribution of the scattered sample signals; and
analyzing the spectrally-resolved, angular scattering distribution of the scattered sample signals to determine characteristic information of the scatterers within the sample.

19. (canceled)

20. The method of claim 18, wherein analyzing the spectrally-resolved, angular scattering distribution of the scattered sample signals comprises determining the depth characteristics of the scatterers within the sample by Fourier transforming the spectrally-resolved, angular scattering distribution of the scattered sample signals.

21. (canceled)

22. The method of claim 18, wherein analyzing the spectrally-resolved, angular scattering distribution of the scattered sample signals comprises determining the size characteristics of the scatterers within the sample by comparing the angular scattering distribution of the scattered sample signals to a predicted analytically or numerically calculated angular scattering distribution of the sample.

23. (canceled)

24. The method of claim 18, wherein scanning the single-mode collection optical fiber comprises translating the single-mode collection optical fiber about the sample to receive the scattered sample signals at the plurality of angles.

25. The method of claim 18, further comprising polarizing the sample signal before the sample signal illuminates the sample.

26. (canceled)

27. An apparatus for determining size characteristics of scatterers within the sample, comprising:
a sample path comprised of an illumination optical fiber configured to carry a sample signal split from a light source, wherein the sample is illuminated with the sample signal at an angle producing scattered sample signals at a plurality of angles off of the sample;
a single-mode collection optical fiber configured to be scanned about the sample to receive the scattered sample signals at the plurality of angles;
a detector configured to detect the scattered sample signals at the plurality of angles to yield an angular scattering distribution of the scattered sample signals; and
a control system configured to analyze the angular scattering distribution of the scattered sample signals to determine size characteristics of the scatterers within the sample.

28. The apparatus of claim 27, wherein the detector is configured to detect the scattered sample signals at the plurality of angles to yield a spectrally-resolved, angular scattering distribution of the scattered sample signals; and
wherein control system is configured to analyzed the spectrally-resolved, angular scattering distribution of the scattered sample signals to determine size characteristics of the scatterers within the sample.

29. (canceled)

30. The apparatus of claim 27, further comprising an actuator configured to translate the single-mode collection optical fiber about the sample to receive the scattered sample signals at the plurality of angles.

31. The apparatus of claim 27, wherein the illumination optical fiber and the single mode collection optical fiber are positioned in a focal plane of a lens disposed between the illumination optical fiber and the single-mode collection optical fiber and the sample.

32. An method of determining size characteristics of scatterers within the sample, comprising:
illuminating a sample at an angle with a sample signal split from a light source and carried by an illumination optical fiber in a sample path to produce scattered sample signals at a plurality of angles off of the sample;
scanning a single-mode collection optical fiber at a plurality of angles to the sample to receive the scattered sample signals at the plurality of angles;
detecting the scattered sample signals at the plurality of angles to yield an angular scattering distribution of the scattered sample signals; and
analyzing the angular scattering distribution of the scattered sample signals to determine size characteristics of the scatterers within the sample.

33. The method of claim 32, further comprising spectrally dispersing the scattered sample signals at the plurality of angles to yield a spectrally-resolved, angular scattering distribution of the scattered sample signals,
wherein analyzing the angular scattering distribution of the scattered sample signals comprising analyzing the spectrally-resolved, angular scattering distribution of the scattered sample signals to determine size characteristics of the scatterers within the sample.

34. (canceled)

35. The method of claim 32, wherein scanning the single-mode collection optical fiber comprises translating the single-mode collection optical fiber about the sample to receive the scattered sample signals at the plurality of angles.
